(19) United States
(12) Patent Application Publication
(10) Pub. No.: US 2016/0361786 A1
(43) Pub. Date: Dec. 15, 2016

(54) FIXTURE ASSEMBLY

(71) Applicant: Caterpillar Inc., Peoria, IL (US)

(72) Inventors: Gabriel J. Ellicott, Peoria Heights, IL (US); John S. Miller, JR., Chillicothe, IL (US); Richard G. Marsh, Lugoff, SC (US); Gerald T. Otten, JR., Washington, IL (US)

(73) Assignee: Caterpillar Inc., Peoria, IL (US)

(21) Appl. No.: 14/737,574

(22) Filed: Jun. 12, 2015

(51) Int. Cl. B23Q 3/12; B23B 13/02; B23B 31/117; B23Q 3/06

(52) U.S. Cl. CPC B23Q 3/12; B23Q 3/062; B23B 13/02; B23B 31/117; B23B 2260/068

(57) ABSTRACT

A fixture assembly for a work piece is provided. The fixture assembly includes a strap assembly including a plurality of straps. One or more parameters associated with each of the plurality of straps is configured to be dynamically adjusted in such a manner that the plurality of straps cooperatively interact with a surface of the work piece. The strap assembly is configured to secure the work piece by providing a clamping force thereon based on an arrangement of the strap assembly.

### TECHNICAL FIELD

The present disclosure relates to a fixture assembly, and more particularly to the fixture assembly for securing a work piece to be machined.

### BACKGROUND

During machining of a work piece using a lathe machine, the work piece is clamped to a frame of the lathe so that the work piece does not move during the machining operation. Clamping of round work pieces generally includes using a 3-jaw chuck or a 4-jaw chuck, or collet systems. Usage of the 3-jaw or 4-jaw chucks can cause deformation of the work piece during clamping and produce geometric errors when a clamping load is removed. The collet systems are costly and may increase cost associated with the machining of the work piece. Further, the collet systems are only useful for a small part size range.

U.S. Pat. No. 8,087,857 describes a method and apparatus to machine a curved surface such as an inner or outer peripheral surface of a pipe. The pipe is held stationary during machining and a rotatable spindle of a machine head moves along multiple orthogonal axes to align the rotational axis of the spindle with the longitudinal pipe axis. The pipe axis is located by using a touch probe to engage the curved surface at multiple spots for calculating the location of the pipe axis. The cutting tool is rotated by the spindle to machine the curved surface.

### SUMMARY OF THE DISCLOSURE

In one aspect of the present disclosure, a fixture assembly for a work piece is provided. The fixture assembly includes a strap assembly including a plurality of straps. One or more parameters associated with each of the plurality of straps is configured to be dynamically adjusted in such a manner that the plurality of straps cooperatively interact with a surface of the work piece. The strap assembly is configured to secure the work piece by providing a clamping force thereon based on an arrangement of the strap assembly.

In another aspect of the present disclosure, a method for securing a work piece to be machined is provided. The method includes positioning the work piece. The method also includes arranging a plurality of straps of a strap assembly in association with the work piece. The method further includes dynamically adjusting one or more parameters associated with each of the plurality of straps. The method includes providing a clamping force on the work piece for securing the work piece based on the arrangement of the strap assembly.

In yet another aspect of the present disclosure, a lathe machine is provided. The lathe machine includes a fixed frame and a cutting tool. The lathe machine also includes a fixture assembly for a work piece. The fixture assembly for a work piece includes a strap assembly including a plurality of straps. One or more parameters associated with each of the plurality of straps is configured to be dynamically adjusted in such a manner that the plurality of straps cooperatively interact with a surface of the work piece. The strap assembly is configured to secure the work piece by providing a clamping force thereon based on an arrangement of the strap assembly.

Other features and aspects of this disclosure will be apparent from the following description and the accompanying drawings.

### BRIEF DESCRIPTION OF THE DRAWINGS

FIG. 1 is a perspective view of an exemplary lathe machine, according to one embodiment of the present disclosure;

FIG. 2 is a side view of an exemplary fixture assembly having a strap assembly, wherein the strap assembly includes three straps to secure a work piece;

FIG. 3 is a side view of a strap assembly, according to one embodiment of the present disclosure;

FIG. 4 is a perspective view of another strap assembly, according to one embodiment of the present disclosure;

FIG. 5 is a side view of yet another strap assembly, according to one embodiment of the present disclosure; and

FIG. 6 is a method for securing the work piece to be machined using the fixture assembly.

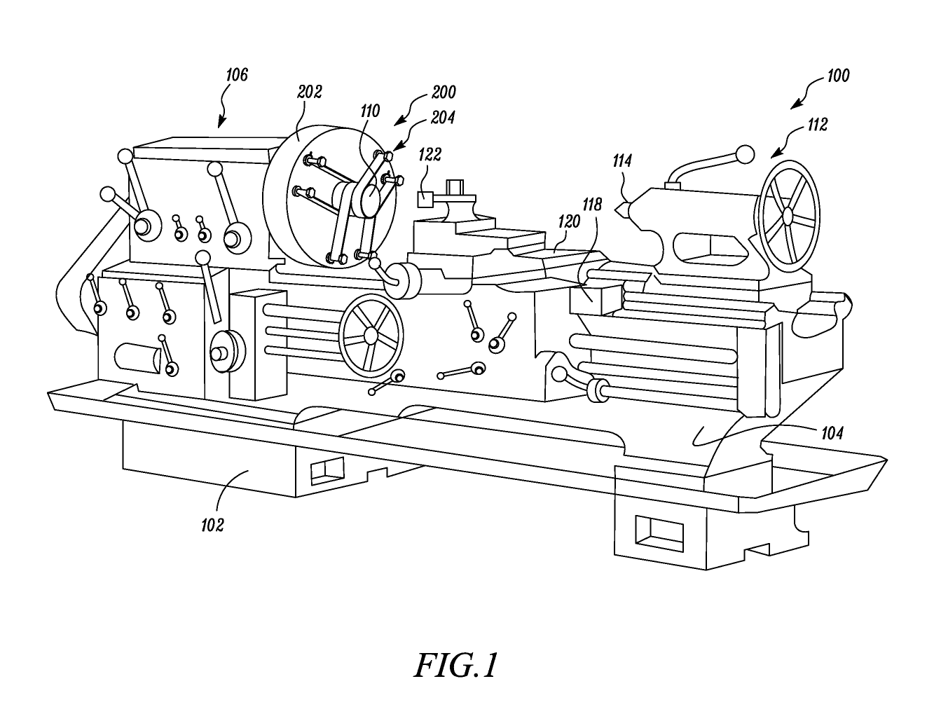

### DETAILED DESCRIPTION

Wherever possible, the same reference numbers will be used throughout the drawings to refer to the same or the like parts. Referring to FIG. 1, an exemplary lathe machine 100 is depicted, according to one embodiment of the present disclosure. Although the present disclosure is explained in reference to a lathe machine 100, it should be understood that the teachings of the present disclosure may apply to other machines such as a grinding machine, milling machine, universal testing machine, boring machine, and the like.

Based on application requirements, the lathe machine 100 may embody any one of a horizontal lathe machine or vertical lathe machine. Further, the lathe machine 100 may include a woodworking lathe machine, metal spinning lathe machine, glass-working lathe machine, a metal working lathe machine, and the like. The lathe machine 100 may embody a floor mounted lathe or a workbench or table mounted lathe, based on system requirements. The lathe machine 100 may be manually controlled. Alternatively, the lathe machine 100 may be controlled using Numerical Controls (NC) or Computerized Numerical Controls (CNC), as per system requirements.

As shown in the accompanying figures, the lathe machine 100 includes a base 102. A bed 104 is mounted on the base 102 of the lathe machine 100. The bed 104 is generally embodied as a horizontal beam that supports various components of the lathe machine 100. Alternatively, the bed 104 may embody a vertical beam or an inclined beam for a CNC lathe machine. The lathe machine 100 includes a headstock 106. The headstock 106 is mounted on the base 102. The headstock 106 includes a spindle (not shown), such that an axis of the spindle is parallel to the bed 104. The spindle is configured to receive a center (not shown) to accurately position a work piece 110. The spindle is powered in order to impart motion to the work piece 110. In one example, the spindle may be driven by a power source. The power source may be an electric motor mounted on the lathe machine 100. Further, the headstock 106 also includes speed changing mechanisms (not shown) to vary speed of the spindle, based on system requirements.

The lathe machine 100 includes a tailstock 112. The tailstock 112 is slidable towards and away from the headstock 106, along a length of the lathe machine 100. The tailstock 112 can be positioned at any location along the length of the lathe machine 100. The tailstock 112 includes a non-rotating barrel 114. The barrel 114 is movable in and out parallel of the tailstock 112 parallel to the bed 104, and directly in line with the spindle. The barrel 114 includes a taper at one end, and is configured to support the work piece 110 during operation.

The lathe machine 100 also includes a saddle 118 that moves back and forth on the bed 104. The saddle 118 supports a cross-slide 120. The saddle 118 may be moved in a direction parallel or perpendicular to the bed 104 of the lathe machine 100. Further, the cross-slide 120 is configured to hold a tool post 122. A cutting tool (not shown) is coupled to the tool post 122. A type of the cutting tool may vary to suit a particular machining operation. The cutting tool may be rotating or non-rotating as per system requirements.

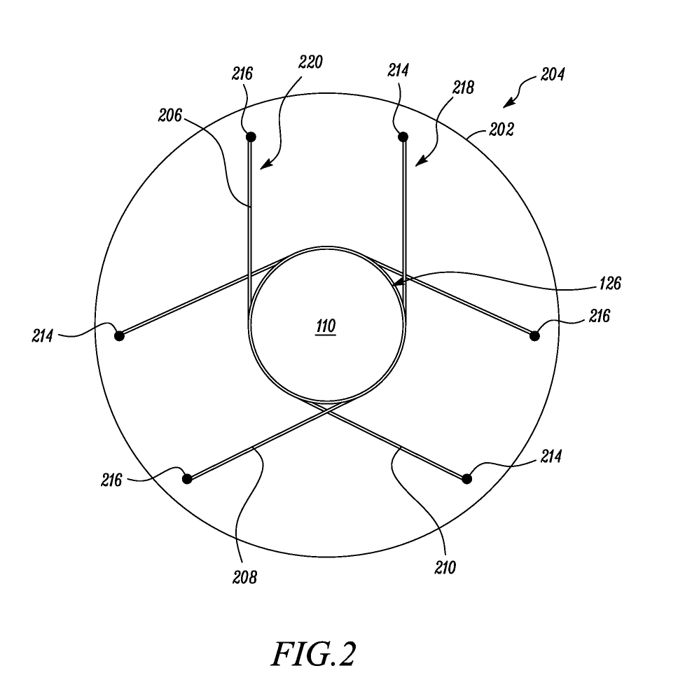

Referring to FIG. 2, a fixture assembly 200 is associated with the lathe machine 100. The fixture assembly 200 is configured to secure the work piece 110 on the lathe machine 100. The fixture assembly 200 includes a frame member 202. The frame member 202 may embody a circular disc with a through aperture to allow the center of the headstock 106 to pass therethrough. The frame member 202 may embody a non-rotating component. In one example, the frame member 202 may be fixedly coupled to the headstock 106.

Referring to FIGS. 2, 3, 4, and 5, the fixture assembly 200 includes a strap assembly 204, 304, 404, 504. The strap assembly 204 will now be described in detail in reference to FIG. 2. The strap assembly 204 is configured to secure the work piece 110 on the lathe machine 100 by providing a clamping force thereon based on an arrangement of the strap assembly 204. The strap assembly 204 includes the straps 206, 208, 210. The straps 206, 208, 210 may be made of a metal or a non-metal. In one example, the straps 206, 208, 210 may be made of nylon. The straps 206, 208, 210 may be made of any material that may be able to hold the work piece 110 during a machining operation. Further, a cross-section of the strap 206, 208, 210 may be round, rectangular, T-shaped, or any other shape known in the art.

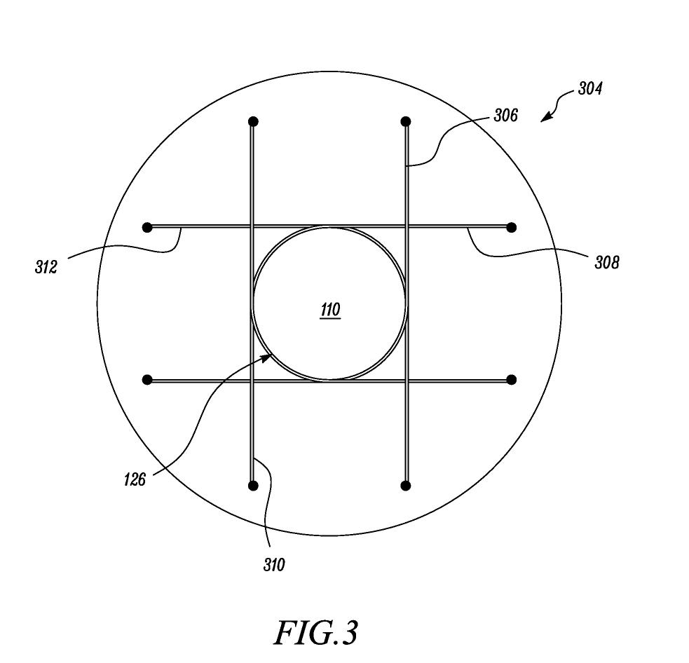

In the fixture assembly 200 shown in the accompanying figures, the strap assembly 204 includes three straps 206, 208, 210. In other embodiments, the strap assembly 204 may include more than two straps and the number of straps may vary based on dimensions of the work piece 110 to be secured. In one embodiment, as shown in FIG. 3, the strap assembly 304 may include four straps 306, 308, 310, 312.

Referring to FIG. 2, the strap assembly 204 may be dynamically adjusted such that the straps 206, 208, 210 cooperatively interact with an outer surface 126 of the work piece 110. More particularly, one or more parameters associated with each of the straps 206, 208, 210 are dynamically adjusted with respect to the work piece 110. The one or more parameters may include a length of the straps 206, 208, 210, a tension in the straps 206, 208, 210, a pressure on the work piece 110, or a combination thereof.

The strap assembly 204 is arranged such that each of the straps 206, 208, 210 is configured to be in a surrounding contacting relationship with the outer surface 126 of the work piece 110. In one embodiment, a thickness of each of the strap 206, 208, 210 is decided such that a combined thickness of the straps 206, 208, 210 is approximately equal to a length of the work piece 110 measured along the length of the bed 104 so that the entire work piece 110 may be covered by the straps 206, 208, 210.

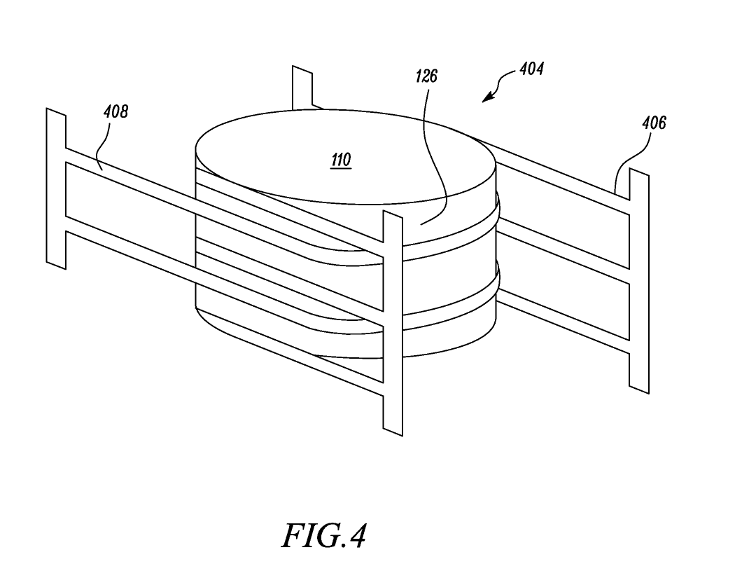

In one embodiment, as shown in FIG. 4, the strap assembly 404 may include an interwoven strap arrangement. Although the strap assembly 404 illustrated in the accompanying figures includes a pair of straps 406, 408 provided in an interwoven manner, the strap assembly 404 may include more than two straps 404, 408, based on system requirements.

Referring to FIG. 2, each of the straps 206, 208, 210 includes a first support 214 and a second support 216 associated therewith. A first end 218 of each of the straps 206, 208, 210 is fixedly attached to the first support 214. The first support 214 may embody a rod member that is fixedly coupled to the frame member 202. The first support 214 extends perpendicularly from a face of the frame member 202. In one example, the first support 214 may include a bolt having a length greater than the thickness of the straps 206, 208, 210. Alternatively, the first support 214 may embody any support member having a square, rectangular, or circular cross section known in the art. The first support 214 may be made of a metal or a non-metal.

Further, a second end 220 of the straps 206, 208, 210 is movably coupled to the second support 216. In one example, the second support 216 may include a ratchet assembly. Alternatively, the second support 216 may include any other adjustment device for adjusting the tension and/or the length of the strap 206, 208, 210 or the pressure on the work piece 110.

In one situation, each of the second supports 216 can be individually adjusted in order to dynamically adjust the straps 206, 208, 210 so that the work piece 110 is securely held and centered within the strap assembly 204. Alternatively, the second supports 216 may be interconnected to a single device such that the second supports 216 may be controlled in order to dynamically adjust the strap assembly 204 by the single device. In one example, the strap assembly 204 may be manually adjusted. Personnel in charge of the machining operation may perform the dynamic adjustment of the straps 206, 208, 210 based on the interaction of the strap assembly 204 and the work piece 110. In another example, the dynamic adjustment of the strap assembly 204 may be performed automatically. In such an example, a control device may be used to perform the dynamic adjustment of the strap assembly 204.

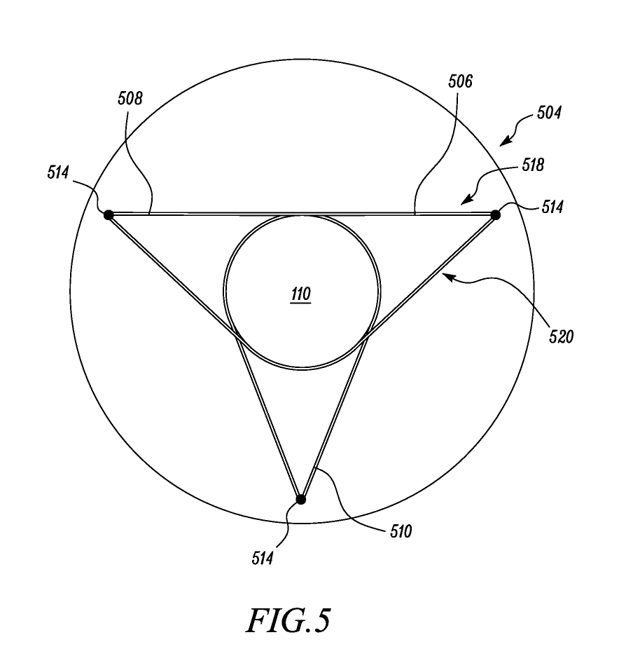

FIG. 5 illustrates another embodiment of the present disclosure. In this embodiment, each of the straps 506, 508, 510 of the strap assembly 504 includes a single support 514. A first portion of the support 514 may serve as a fixed means for the first end 518 of the strap assembly 504 to couple to. Further, the second end 520 of the straps 506, 508, 510 may couple to a second portion of the support 514. The second portion of the support 514 may include suitable adjustment means to movably couple the straps 506, 508, 510 to the second portion of the support 514.

Further, the strap assembly 204, 304, 404, 504 may include a detection device (not shown) to determine whether the strap assembly 204, 304, 404, 504 is taut in order to maintain stability and proper positioning of the work piece 110. The detection device may include a pressure sensor, a tension sensor, a run-out indicator, or a combination thereof. The pressure sensor may provide an indication of the pressure applied by the strap assembly 204, 304, 404, 504 on the work piece 110. The tension sensor may detect the tension in the strap assembly 204, 304, 404, 504. The run out indicator may provide an indication of the length of the straps 206, 208, 210, 306, 308, 310, 312, 406, 408, 506, 508, 510, 512 for adjustment thereof.

In a situation wherein the pressure on the work piece 110 or tension in the strap 206, 208, 210, 306, 308, 310, 312, 406, 408, 506, 508, 510, 512 requires adjustment, the operator may be appropriately notified. In a situation in which the strap assembly 204, 304, 404, 504 is to be automatically adjusted, based on signals received from the pressure sensor, the tension sensor, and/or the run out indicator, the control device may appropriately adjust the strap assembly 204, 304, 404, 504 associated with the work piece 110.

### INDUSTRIAL APPLICABILITY

The present disclosure is directed towards the strap assembly 204, 304, 404, 504 for the lathe machine 100. The strap assembly 204, 304, 404, 504 is configured to secure the work piece 110 by providing the clamping force thereon based on the arrangement of the strap assembly 204, 304, 404, 504. The strap assembly 204, 304, 404, 504 includes a number of straps 206, 208, 210, 306, 308, 310, 312, 406, 408, 506, 508, 510, 512 respectively that may be individually and dynamically adjusted in order to hold and center the work piece 110 within the strap assembly 204, 304, 404, 504. In alternate embodiments, all the straps 206, 208, 210, 306, 308, 310, 312, 406, 408, 506, 508, 510, 512 of the strap assembly 204, 304, 404, 504 respectively can be adjusted centrally.

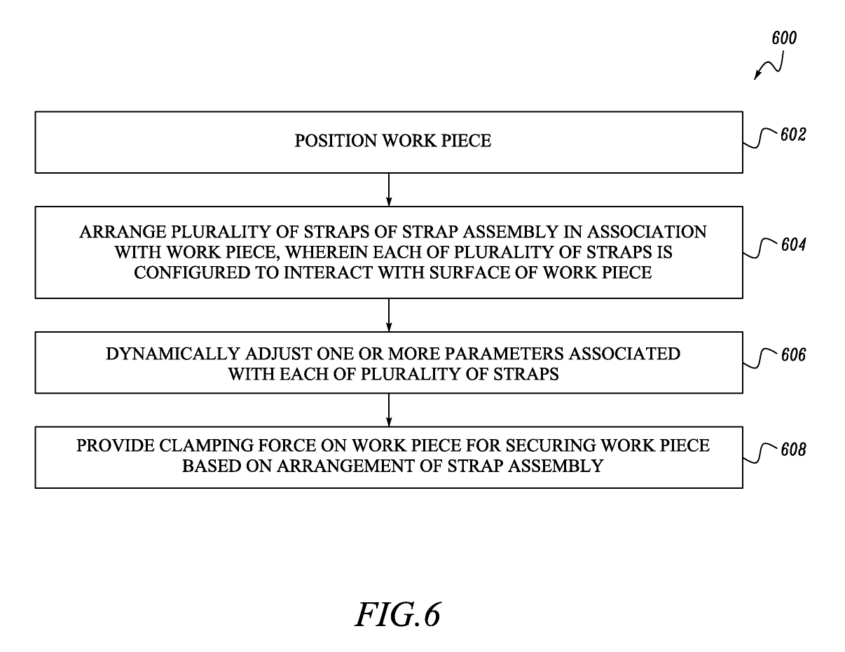

FIG. 6 is a flowchart for a method 600 for securing the work piece 110 to be machined. The method 600 will be explained with reference to the embodiment illustrated in FIG. 2 for the purpose of simplicity, but the method 600 is also applicable to other embodiments without any limitations. At step 602, the work piece 110 is positioned with respect to the center of the spindle. At step 602, the straps 206, 208, 210 (see FIG. 2) of the strap assembly 204, are arranged in association with the work piece 110. The first end 218 of each of the straps 206, 208, 210 is fixedly attached to the first support 214. Further, the second end 220 of each of the straps 206, 208, 210 is movably attached to the second support 216. Each of the straps 206, 208, 210 is configured to interact with the outer surface 126 of the work piece 110.

At step 606, one or more parameters associated with each of the straps 206, 208, 210 are dynamically adjusted. In one example, the dynamic adjustment of the straps 206, 208, 210 may be done automatically. In another example, the dynamic adjustment of the straps 206, 208, 210 may be done manually. At step 608, the clamping force is provided on the work piece 110 for securing the work piece 110 based on the arrangement of the strap assembly 204.

The strap assembly 204, 304, 404, 504 described herein does not make use of expensive components and hence is a cost effective solution. Further, the strap assembly 204, 304, 404, 504 does not create deformations and geometric errors on the work piece 110 when a clamping load is removed. The strap assembly 204, 304, 404, 504 can be used to secure the work pieces of irregular shapes. Further, the strap assembly 204, 304, 404, 504 can also account for the size of the work piece. The strap assembly 204, 304, 404, 504 can be used for a large part size range. Based on the size of the work piece, the number of straps associated with a single strap assembly may vary in order to accommodate large work piece dimensions.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A fixture assembly for a work piece, the fixture assembly comprising:
a strap assembly including a plurality of straps, wherein one or more parameters associated with each of the plurality of straps is configured to be dynamically adjusted in such a manner that the plurality of straps cooperatively interact with a surface of the work piece,
wherein the strap assembly is configured to secure the work piece by providing a clamping force thereon based on an arrangement of the strap assembly.

2. The fixture assembly of claim 1, wherein the one or more parameters includes at least one of a length of the strap, a tension in the strap, and a combination thereof.

3. The fixture assembly of claim 1, wherein one end of each of the plurality of straps is fixedly attached to a support.

4. The fixture assembly of claim 3, wherein another end of each of the plurality of straps is movably attached to the support.

5. The fixture assembly of claim 4 further comprising a ratchet assembly provided at the another end of each of the plurality of straps.

6. The fixture assembly of claim 1 further comprising at least one of a pressure sensor, a tension sensor, and a run out indicator associated with each of the plurality of straps.

7. The fixture assembly of claim 1, wherein the dynamic adjustment of the plurality of straps is done automatically.

8. The fixture assembly of claim 1, wherein the dynamic adjustment of the plurality of straps is done manually.

9. The fixture assembly of claim 1, wherein the arrangement of the plurality of straps is such that the plurality of straps is configured to be in a surrounding contacting relationship with the surface of the work piece.

10. A method for securing a work piece to be machined, the method comprising:
positioning the work piece;
arranging a plurality of straps of a strap assembly in association with the work piece, wherein each of the plurality of straps is configured to interact with a surface of the work piece;
dynamically adjusting one or more parameters associated with each of the plurality of straps; and
providing a clamping force on the work piece for securing the work piece based on the arrangement of the strap assembly.

11. The method of claim 10, wherein the one or more parameters includes at least one of a length of the strap, a tension in the strap, and a combination thereof.

12. The method of claim 10 further comprising:
fixedly attaching one end of each of the plurality of straps to a support.

13. The method of claim 12 further comprising:
movably attaching another end of each of the plurality of straps to the support.

14. The method of claim 10, wherein the dynamic adjustment of the plurality of straps is done automatically.

15. The method of claim 10, wherein the dynamic adjustment of the plurality of straps is done manually.

16. The method of claim 10, wherein the arranging of the plurality of straps is such that the plurality of straps is in a surrounding contacting relationship with the surface of the work piece.

17. A lathe machine comprising:
a fixed frame;
a cutting tool; and
a fixture assembly for a work piece, the fixture assembly comprising:
a strap assembly including a plurality of straps, wherein one or more parameters associated with each of the plurality of straps is configured to be dynamically adjusted in such a manner that the plurality of straps cooperatively interact with a surface of the work piece,
wherein the strap assembly is configured to secure the work piece by providing a clamping force thereon based on an arrangement of the strap assembly.

18. The lathe machine of claim 17, wherein the one or more parameters includes at least one of a length of the strap, a tension in the strap, and a combination thereof.

19. The lathe machine of claim 17, wherein one end of each of the plurality of straps is fixedly attached to a support.

20. The lathe machine of claim 19, wherein another end of each of the plurality of straps is movably attached to the support.
